(19) United States
(12) Patent Application Publication
(10) Pub. No.: US 2025/0234864 A1
(43) Pub. Date: Jul. 24, 2025

(54) PLANT DISEASE CONTROL COMPOSITION, FORMULATION, AND PLANT DISEASE CONTROL METHOD

(71) Applicant: MITSUI CHEMICALS CROP & LIFE SOLUTIONS, INC., Tokyo (JP)

(72) Inventors: Yukiko TAKIGUCHI, Mobara-shi, Chiba (JP); Takeshi TERAOKA, Chuo-ku, Tokyo (JP); Kentaro YAMAMOTO, Mobara-shi, Chiba (JP)

(21) Appl. No.: 18/848,407

(22) PCT Filed: Mar. 17, 2023
(86) PCT No.: PCT/JP2023/010759

§ 371 Date: Sep. 18, 2024

(30) Foreign Application Priority Data
Mar. 28, 2022 (JP) 2022-052592

(51) Int. Cl. A01N 43/42; A01N 37/18; A01N 43/40; A01N 43/56; A01N 43/60; A01N 43/653; A01N 43/88; A01N 43/90; A01P 3/00

(52) U.S. Cl. CPC A01N 43/42; A01N 37/18; A01N 43/40; A01N 43/56; A01N 43/60; A01N 43/653; A01N 43/88; A01N 43/90; A01P 3/00

(57) ABSTRACT

A plant disease control composition includes Tebufloquin and a microbicide other than Tebufloquin as active components. The microbicide includes at least one selected from the group consisting of Pyraclostrobin, Picoxystrobin, Fluoxastrobin, Mandestrobin, Trifloxystrobin, Azaconazol, Bitertanol, Bromuconazole, Ciproconazole, Diphenoconazole, Diniconazole, Epoxiconazole, Etaconazole, Fenbuconazole, Fluquinconazole, Flusilazole, Flutriafol, Hexaconazole, Imibenconazole, Ipconazole, Mefentrifluconazole, Metconazole, Myclobutanil, Penconazole, Propiconazole, Prothioconazole, Simeconazole, Mefentrifluconazole, Tebuconazole, Tetraconazole, Triadimefon, Triadimenol, Triticonazole, Penflufen, Inpyrfluxam, Fluindapyr, Pyraziflumid, Penthiopyrad, Fluopyram, Pyridachlometyl, Pyroquilon, and Ipflufenoquin.

### TECHNICAL FIELD

The present disclosure relates to a plant disease control composition, a formulation, and a plant disease control method.

### BACKGROUND ART

Rice blast, which is caused by Pyricularia oryzae, is a disease that that causes the most extensive damage in wet rice cultivation, and a large number of control agents including fungicidal compounds have been reported. Many of them are directed to preventive use in which treatment is performed prior to onset of rice blast.

Numerous variants having resistance to existing fungicidal compounds have emerged in rice blast, and farm fields at which use of one fungicidal component is insufficient for providing a satisfactory control effect are increasing (see Non-Patent Document 1).

Techniques have been proposed with respect to control agents that include fungicidal compounds or the like (see, for example, Patent Documents 1 and 2). It has also been demonstrated that a mixture of a diamine derivative having an oxycarbonyl group having a halogen-substituted hydrocarbon and another fungicidal compound such as Tebufloquin exhibits an activity against plant diseases including rice blast (see Patent Document 3). It has also been demonstrated that a mixture of an amide compound and another fungicidal compound such as Tebufloquin exhibits an activity against Botrytis cinerea (see Patent Document 4). In addition, it has been demonstrated that a mixed composition of Tebufloquin and a fungicidal compound exhibits an activity against Erysiphe graminis (see Patent Document 5).
Patent Document 1 Japanese Patent Application Laid-open (JP-A) No. 2003-55114
Patent Document 2 International Publication (WO) No. 2004/039156
Patent Document 3 International Publication (WO) No. 2006/106811
Patent Document 4 Japanese Patent Application Laid-open (JP-A) No. 2011-201858
Patent Document 5 Japanese Patent Application Laid-open (JP-A) No. 2007-112760
Non-Patent Document 1: “Yakuzai-Taiseikin Kenkyuu-no Saishindoukou-to Taisakukyouka-ni-mukete” (Latest Trend in Research of Agrochemical Resistant Microorganisms and Plans for Strengthening of Countermeasures) Nihon-Nouyaku-Gakkaishi (Bulletin of Pesticide Science Society of Japan), vol. 39, issue 1 (2014), pp. 53-57

### SUMMARY OF INVENTION

### Technical Problem

In consideration of the foregoing circumstances, it is desirable to find a technique whereby microbicides having different action modes are mixed for plant disease control, as a measure to prevent emergence of further microbicide-resistant microorganisms.

A problem to be solved by one embodiment of the present disclosure is to provide a plant disease control composition that exhibits an excellent control effect against plant diseases as compared to plant disease control compositions that include Tebufloquin as the only active component.

A problem to be solved by another embodiment of the present disclosure is to provide a formulation and a plant disease control method in which the plant disease control composition is used.

### Solution to Problem

The inventors of the present application have found that Tebufloquin and a specific microbicide other than Tebufloquin produce a synergistic plant disease control effect, and have made the present invention.

Specific means for solving the problems include the following aspects.

<1> A plant disease control composition including Tebufloquin and a microbicide other than Tebufloquin as active components,
the microbicide including at least one selected from the group consisting of Pyraclostrobin, Picoxystrobin, Fluoxastrobin, Mandestrobin, Trifloxystrobin, Azaconazol, Bitertanol, Bromuconazole, Ciproconazole, Diphenoconazole, Diniconazole, Epoxiconazole, Etaconazole, Fenbuconazole, Fluquinconazole, Flusilazole, Flutriafol, Hexaconazole, Imibenconazole, Ipconazole, Mefentrifluconazole, Metconazole, Myclobutanil, Penconazole, Propiconazole, Prothioconazole, Simeconazole, Mefentrifluconazole, Tebuconazole, Tetraconazole, Triadimefon, Triadimenol, Triticonazole, Penflufen, Inpyrfluxam, Fluindapyr, Pyraziflumid, Penthiopyrad, Fluopyram, Pyridachlometyl, Pyroquilon, and Ipflufenoquin.
   <2> The plant disease control composition according to <1>, wherein the microbicide includes at least one selected from the group consisting of Pyraclostrobin, Picoxystrobin, Fluoxastrobin, Mandestrobin, Trifloxystrobin, Prothioconazole, Mefentrifluconazole, Ciproconazole, Diphenoconazole, Hexaconazole, Propiconazole, Tebuconazole, Penflufen, Inpyrfluxam, Pyraziflumid, Pyroquilon, and Ipflufenoquin.
   <3> The plant disease control composition according to <1> or <2>, wherein the plant disease is blast disease.
   <4> A formulation including the plant disease control composition of any one of <1> to <3>.
   <5> The formulation according to <4>, wherein the formulation is selected from the group consisting of a wettable powder formulation, an emulsifiable concentrate formulation, a flowable formulation, a water-dispersible granule formulation, a dry flowable formulation, a dust formulation, a low drift (DL) dust formulation, a flow dust (FD) formulation, a microcapsule formulation, a granule formulation, a dust-granule mixture formulation; a jumbo-pellet formulation, a pack formulation, and an aerosol formulation.
   <6> A plant disease control method including applying the plant disease control composition of any one of <1> to <3> to a plant disease.
   <7> The plant disease control method according to <6>, wherein the plant disease is blast disease.
   <8> The plant disease control method according to <6> or <7>, wherein the applying includes at least one treatment selected from foliar application or seedling box treatment.

### Advantageous Effects of Invention

According to one embodiment of the present disclosure, a plant disease control composition is provided which exhibits an excellent control effect against plant diseases, as compared to plant disease control compositions that include Tebufloquin as the only active component. According to another embodiment of the present disclosure, a formulation and a plant disease control method in which the plant disease control composition is used are provided.

### MODES FOR CARRYING OUT INVENTION

Embodiments according to the present disclosure are described below. The descriptions and the Examples provided below are provided only for illustrating embodiments according to the present disclosure, and do not limit the scope of the present disclosure.

In the present specification, any numerical range expressed using “to” means a range including numerical values described before and after “to” as a lower limit value and an upper limit value.

For numerical value ranges described in a stepwise manner in the present specification, the upper limit value or the lower limit value of one numerical value range may be replaced with the upper limit value or the lower limit value of another numerical value range in the stepwise description.

The upper limit value or the lower limit value of any numerical value range described in the present specification may also be replaced with a value described in Examples.

In the present specification, the amount of each component in a material of interest means, when plural substances corresponding to the component exist in the material, a total content or content ratio of the plural substances present in the material, unless otherwise specified.

An embodiment according to the present disclosure relates to a plant disease control composition that includes Tebufloquin and a specific microbicide other than Tebufloquin as active components.

The mechanism whereby the effect is produced by the plant disease control composition according to the present disclosure is not completely clear, but we surmise that the following mechanism works.

In the plant disease control composition according to the present disclosure, a microbicide Tebufloquin, which does not produce a sufficient control effect against a plant disease by itself in some cases, is combined with a specific microbicide that has an action mode different from that of Tebufloquin. When the plant disease control composition according to the present disclosure is applied, a synergistic plant disease control effect based on the microbicidal effects of Tebufloquin and the specific microbicide having a different action mode is produced, thereby enabling efficient control of plant diseases, a representative example of which is rice blast. Further, the plant disease control composition according to the present disclosure can reduce a possibility of emergence of microbicide-resistant microorganisms.

The plant disease control composition according to the present disclosure has a potential to significantly contribute to stabilization of agricultural production.

The microbicide, other than Tebufloquin, according to the present disclosure includes at least one selected from the group consisting of Pyraclostrobin, Picoxystrobin, Fluoxastrobin, Mandestrobin, Trifloxystrobin, Azaconazol, Bitertanol, Bromuconazole, Ciproconazole, Diphenoconazole, Diniconazole, Epoxiconazole, Etaconazole, Fenbuconazole, Fluquinconazole, Flusilazole, Flutriafol, Hexaconazole, Imibenconazole, Ipconazole, Mefentrifluconazole, Metconazole, Myclobutanil, Penconazole, Propiconazole, Prothioconazole, Simeconazole, Mefentrifluconazole, Tebuconazole, Tetraconazole, Triadimefon, Triadimenol, Triticonazole, Penflufen, Inpyrfluxam, Fluindapyr, Pyraziflumid, Penthiopyrad, Fluopyram, Pyridachlometyl, Pyroquilon, and Ipflufenoquin (which are also collectively referred to as “specific microbicide other than Tebufloquin” or “microbicide to be combined with Tebufloquin” hereinafter).

Pyraclostrobin, Picoxystrobin, Fluoxastrobin, Mandestrobin, and Trifloxystrobin are classified as strobilurin-based microbicides.

Azaconazol, Bromuconazole, Ciproconazole, Diphenoconazole, Diniconazole, Epoxiconazole, Etaconazole, Fenbuconazole, Fluquinconazole, Hexaconazole, Imibenconazole, Ipconazole, Mefentrifluconazole, Metconazole, Penconazole, Propiconazole, Prothioconazole, Simeconazole, Mefentrifluconazole, Tebuconazole, Tetraconazole, Triticonazole, Myclobutanil, Bitertanol, Flusilazole, Flutriafol, Triadimefon, and Triadimenol are classified as microbicides having sterol demethylase inhibiting activity.

Penflufen, Inpyrfluxam, Fluindapyr, Pyraziflumid, Penthiopyrad, and Fluopyram are classified as microbicides having succinate dehydrogenase inhibiting activity.

Microbicides that are preferable for use as the microbicide other than Tebufloquin (i.e., preferable for use as the microbicide to be combined with Tebufloquin) include Pyraclostrobin, Picoxystrobin, Fluoxastrobin, Mandestrobin, Trifloxystrobin, Ciproconazole, Diphenoconazole, Hexaconazole, Propiconazole, Prothioconazole, Mefentrifluconazole, Tebuconazole, Penflufen, Inpyrfluxam, Pyraziflumid, Pyroquilon, and Ipflufenoquin.

In the plant disease control composition according to the present disclosure, the mixing ratio of Tebufloquin to the microbicide to be combined with Tebufloquin in terms of mass ratio is preferably 1:0.0001 to 1:10 (Tebufloquin:microbicide to be combined with Tebufloquin) when the microbicide to be combined with Tebufloquin is a strobilurin-based micribocide. When the microbicide to be combined with Tebufloquin is a microbicide having sterol demethylase inhibiting activity, the mass ratio is preferably 1:0.05 to 1:20 (Tebufloquin:microbicide to be combined with Tebufloquin). When the microbicide to be combined with Tebufloquin is a microbicide having succinate dehydrogenase inhibiting activity, the mass ratio is preferably from 1:0.05 to 1:20 (Tebufloquin:microbicide to be combined with Tebufloquin).

More preferably the mixing ratio in terms of mass ratio is from 1:0.0005 to 1:2 when the microbicide to be combined with Tebufloquin is selected from Pyraclostrobin, Picoxystrobin, Fluoxastrobin, Mandestrobin, or Trifloxystrobin, or from 1:0.1 to 1:20 when the microbicide to be combined with Tebufloquin is selected from Mefentrifluconazole, Propiconazole, or Diphenoconazole, or from 1:0.1 to 1:5 when the microbicide to be combined with Tebufloquin is selected from Tebuconazole, Hexaconazole, Ciproconazole, or Simeconazole, or from 1:0.1 to 1:4 when the microbicide to be combined with Tebufloquin is selected from Penflufen, Inpyrfluxam, Penthiopyrad, or Pyroquilon, or from 1:0.05 to 1:10 when the microbicide to be combined with Tebufloquin is Propiconazole, or from 1:0.1 to 1:10 when the microbicide to be combined with Tebufloquin is Pyraziflumid, or from 1:0.0001 to 1:2 when the microbicide to be combined with Tebufloquin is Ipflufenoquin.

In the plant disease control composition according to the present disclosure, the total content of Tebufloquin and the specific microbicide other than Tebufloquin in the plant disease control composition is not limited, and the total content (in terms of mass) may be appropriately set within the range of from 0.01 to 90 parts by mass with respect to 100 parts by mass of the plant disease control composition. The total content is preferably in the range of from 0.1 parts by mass to 50 parts by mass with respect to 100 parts by mass of the plant disease control composition.

Examples of the phytopathogen to be controlled with the plant disease control composition according to the present disclosure include, but are not limited to, fungi, bacteria, viruses, and the like.

Examples of the fungi include phytopathogenic fungi, examples of the bacteria include phytopathogenic bacteria, and examples of the viruses include phytopathogenic viruses.

Examples of the phytopathogenic fungi include Alternaria alternata, Alternaria kikutiana, Botrytis cinerea, Cochliobolus miyabeanus, Colletotrichum atramentarium, Colletotrichum lagenarium, Fusarium oxysporum f. sp. cucumerinum, Fusarium oxysporum f. sp. lycopersici, Gibberella fujikuroi, Glomerella cingulata, Pyricularia oryzae, Rhizoctonia solani, Sclerotinia minor, Verticillium albo-atrum, Puccinia recondita, Erysiphe graminis, Phytophthora infestans, Pseudoperonospora cubensis, Sphaerotheca fuliginea, Pythium graminicola, Alternaria solani, Sclerotinia sclerotiorum, Venturia inaequalis, Monilinia fructicola, Colletotrichum gloeosporioides, Cercospora kikuchii, Cercospora beticola, Leptosphaeria nodorum, Blumeria graminis, and Thanatephorus cucumeris (Frank) Donk.

Among the phytopathogenic fungi exemplified above, preferable phytopathogenic fungi for which the plant disease control composition according to the present disclosure exhibits a particularly superior control effect include Cochliobolus miyabeanus, Gibberella fujikuroi, Pyricularia oryzae, Pythium graminicola, and Thanatephorus cucumeris (Frank) Donk. An example of a more prefertable phytopathogenic fungi is Pyricularia oryzae.

Examples of the phytopathogenic bacteria include bacteria of the genus Pseudomonas, the genus Erwinia, the genus Pectobacterium, the genus Xanthomonas, the genus Burkholderia, the genus Streptomyces, the genus Ralstonia, the genus Clavibacter, the genus Rhizomonas, the genus Agrobacterium, the genus Bacillus, the genus Clostridium, the genus Curtobacterium, the genus Pantoea, the genus Acidovorax, the genus Arthrobacter, and the genus Rhodococcus.

Examples of the phytopathogenic viruses include Soil-borne wheat mosaic virus, Soybean mosaic virus, Alfalfa mosaic virus, Potato leaf roll virus, Cucumber mosaic virus, and Tobacco mosaic virus.

When the plant disease control composition according to the present disclosure is used as a formulation, the plant disease control composition according to the present disclosure may be used as it is.

The plant disease control composition according to the present disclosure may be formulated into any dosage form, using an ordinary method. Examples of the dosage form of the formulation include a wettable powder formulation, an emulsifiable concentrate formulation, a flowable formulation, a water-dispersible granule formulation, a dry flowable formulation, a dust formulation, a low drift (DL) dust formulation, a flow dust (FD) formulation, and a microcapsule formulation.

The formulation is preferably an agrochemical formulation for use as an agricultural chemical.

The DL dust formulation as used herein refers to a less drifting formulation having an average particle size of 20 μm or more, in which the proportion of particles having particle sizes of 10 μm or less is 20% or less. The FD formulation as used herein refers to a formulation that utilizes floating and has an average particle size of 5 μm or less.

The plant disease control composition according to the present disclosure may be used in any formulation, such as a granule formulation, a dust-granule mixture formulation; a jumbo-pellet formulation, a pack formulation, or an aerosol formulation, to be used in the water in the main field or the seedling box.

These formulations can be produced with optional addition of agriculturally or horticulturally acceptable additive, if necessary. Examples of the agriculturally or horticulturally acceptable additive include carriers, surfactants, moistening agents, fixing agents, thickening agents, binding agents, antifreezing agents, coloring agents, and auxiliary agents.

Examples of the carriers include solid carriers, liquid carriers, and gaseous carriers.

With such additives, formulations for agricultural chemicals can be produced using an ordinary production method.

Examples of the solid carriers include: fine powder or granules of a clay (such as clay, kaolin, diatomaceous earth, bentonite, or acid clay), synthetic hydrous silicon dioxide, talc, perlite, vermiculite, pumice, or another inorganic mineral (such as sericite, quartz, sulfur, activated carbon, calcium carbonate, hydrated silica, or titanium oxide); starch; lactose; a synthetic polymer such as a vinyl chloride polymer or a polyurethane; and a plant-derived materials such as wood dust.

Examples of the liquid carriers include alcohols (such as methanol, ethanol, isopropanol, polyethyleneglycol, propyleneglycol, dipropyleneglycol, tripropyleneglycol, and glycerin), ketones (such as acetone and methyl ethyl ketone), aromatic hydrocarbons (such as benzyl alcohol, benzene, toluene, xylene, ethylbenzene, and methylnaphthalene), aliphatic hydrocarbons (such as paraffin, n-hexane, cyclohexane, kerosene, and heating oil), ethers (such as diethyleneglycol monoethyl ether, diethyleneglycol monomethyl ether, diisopropyl ether, diethyl ether, dioxane, and tetrahydrofuran), esters (such as propylene carbonate, ethyl acetate, butyl acetate, benzyl bonzoate, isopropyl myristate, and a fatty acid ester of propylene glycol), nitriles (such as acetonitril and isobutyronitrile), amides (such as dimethylformamide, dimethylacetamide, and N-methylpyrrolidone), halogenated hydrocarbons (such as dichloromethane, trichloroethane, and carbon tetrachloride), animal and plant oils such as soybean oil and cotton seed oil, dimethylsulfoxide, silicone oil, higher fatty acids, glycerol formal, and water.

Examples of the gaseous carriers include liquid petroleum gas (LPG), air, nitrogen, carbon dioxide gas, and dimethyl ether.

The content of carrier used in the plant disease control composition according to the present disclosure is usually from 5% by mass to 99.9% by mass, and preferably from 10% by mass to 98% by mass, with respect to the plant disease control composition.

Surfactants are used for various purposes such as emulsification, dispersion, penetration, and disintegration. Any surfactant that is used in a usual agricultural chemical can be used as the surfactant that may be used in the plant disease control composition according to the present disclosure, without particular limitations, and any type of surfactant such as an anionic surfactant, a nonionic surfactant, a cationic surfactant, or an amphoteric surfactant may be used. The surfactant may be used singly, or in combination of two or more thereof.

Examples of the anionic surfactant include alkyl phosphate ester salts, alkyl sulfate ester salts, polyoxyalkylene alkyl ether phosphate ester salts, polyoxyethylene alkyl ether sulfate ester salts, alkyl aryl phosphate ester salts, alkyl aryl sulfate ester salts, polyoxyalkylene alkyl aryl ether phosphate ester salts, polyoxyalkylene alkyl aryl ether sulfate ester salts, alkyl phenol phosphate salts, alkyl phenol phosphate ester salts, alkyl phenol sulfate salts, alkyl phenol sulfate ester salts, polyoxyalkylene alkyl phenol phosphate salts, polyoxyalkylene alkyl phenol phosphate ester salts, polyoxyalkylene alkyl phenol sulfate salts, polyoxyalkylene alkyl phenol sulfate ester salts, styrylphenol phosphate salts, styrylphenol phosphate ester salts, styrylphenol sulfate salts, styrylphenol sulfate ester salts, polyoxyalkylene styrylphenol phosphate salts, polyoxyalkylene styrylphenol phosphate ester salts, polyoxyalkylene styrylphenol sulfate salts, polyoxyalkylene styrylphenol sulfate ester salts, distyrylphenol phosphate salts, distyrylphenol phosphate ester salts, distyrylphenol sulfate salts, distyrylphenol sulfate ester salts, polyoxyalkylene distyrylphenol phosphate salts, polyoxyalkylene distyrylphenol phosphate ester salts, polyoxyalkylene distyrylphenol sulfate salts, polyoxyalkylene distyrylphenol sulfate ester salts, tristyrylphenol phosphate salts, tristyrylphenol phosphate ester salts, tristyrylphenol sulfate salts, tristyrylphenol sulfate ester salts, polyoxyalkylene tristyrylphenol phosphate salts, polyoxyalkylene tristyrylphenol phosphate ester salts, polyoxyalkylene tristyrylphenol sulfate salts, polyoxyalkylene tristyrylphenol sulfate ester salts, alkyl succinate sulfonic acid salts, dialkyl succinate sulfonic acid salts, and polyoxyalkylene dialkyl succinate sulfonic acid salts.

Examples of the nonionic surfactant include aliphatic alcohol alkylene oxide adducts, polyalkyleneoxy fatty acid esters, sorbitan-based surfactants or alkylene oxide adducts thereof, polyglycerin fatty acid esters, alkyl polysaccharide-based surfactants, sucroglycerides, polyoxyalkylene alkyl ethers, polyoxyethylene alkyl ethers, polyoxyalkylene alkylaryl ethers, polyoxyalkylene alkylphenol ethers, polyoxyalkylene styrylphenol ethers, polyoxyalkylene distyrylphenol ethers, and polyoxyalkylene tristyrylphenol ethers.

Examples of the cationic surfactant include aliphatic tertiary amines or salts thereof, aliphatic tertiary amine aliphatic amine alkylene oxide adducts or salts thereof, and aliphatic quaternary amine salts.

Examples of the amphoteric surfactant include: amino acid-based amphoteric surfactants such as sodium laurylaminopropionate; carboxylic acid salt-based amphoteric surfactants such as betaine-based amphoteric surfactants such as lauryl dimethyl betaine, stearyl dimethyl betaine, and lauryl dihydroxyethyl betaine; sulfate ester salt-based amphoteric surfactants; sulfonic acid salt-based amphoteric surfactants; and phosphoric ester salt-based amphoteric surfactants.

In general, the amount of surfactant used in the plant disease control composition according to the present disclosure is preferably from 0.01% by mass to 30% by mass, and more preferably from 0.05% by mass to 20% by mass, with respect to the plant disease control composition.

Examples of the moistening agents include polyoxyethylene alkylphenyl ethers, sodium alkylbenzene sulfonates, dioctyl sulfosuccinate, sodium alkylnaphthalene sulfonates, sodium alkyl sulfates, sodium alkylnaphthalene sulfonates, sodium alkylbenzene sulfonates, alkyl sulfosuccinate sodium salts, polyoxyethylene alkylaryl ethers, sodium alkylnaphthalene sulfonates, and polyoxyethylene nonylphenyl ether.

Examples of the fixing agents include polyacrylic acid salts, polyoxyethylene, wax, polyvinyl alkyl ethers, formalin condensates of alkylphenols, phosphoric esters of starch, synthetic resin emulsions, starches, resin powder, water-swellable polymer substances, and paraffin.

Any thickening agent that is usually used in an agricultural chemical formulation can be used, without particular limitations. Examples of the thickening agents include: minerals such as white carbon, aluminosilicate salts, bentonite, montmorillonite, hectorite, attapulgite; and polymer thickening agents such as gum arabic, gum tragacanth, xanthan gum, guar gum, roast bean gum, casein, alginic acid, cellulose-based polysaccharides, ethyl cellulose, polyvinyl alcohol, carboxymethyl cellulose, hydroxyethyl cellulose, hydroxypropyl cellulose, and carboxymethyl cellulose.

The application amount of the plant disease control composition according to the present disclosure is not limited, and may appropriately be set in accordance with, for example, the weather of the region at which the control of plant diseases is to be performed, environmental conditions, culture conditions, growth situation, the timing of application, the application method, and disease development-related factors such as the severity of the disease.

With respect to an effective application amount of the plant disease control composition, the plant disease control composition may be applied in a range of from 0.01 g to 10 kg per 10 ares, and more preferably in a range of from 1 g to 5 kg per 10 ares.

Ordinarily, the plant disease control composition according to the present disclosure may be applied at any time in any crop culture period in which an agricultural chemical is used, more specifically, at any time in a period or periods selected from a period prior to seeding, a germination period, a seedling raising period, a vegetable growth period, or a preharvest period.

In a preferable usage of the plant disease control composition according to the present disclosure, the plant disease control composition may be applied at any time in a period or periods selected from a post-germination seedling raising period, a period of cultivation in a main field, or a preharvest period, in the rice cultivation periods. In a more preferable usage, the plant disease control composition may be applied in periods from a seedling raising period until a pre-harvest period.

Examples of the manner of application of the plant disease control composition according to the present disclosure include: foliar application to plant bodies; seedling box treatment; side dressing using a rice translplanter; submerged application in flooded water; spreading onto the soil surface; soil incorporation after spreading onto the soil surface; injection into the soil; soil incorporation after injection into the soil; soil drenching; soil incorporation after soil drenching; spraying onto plant seeds; coating onto plant seeds; application by immersion of plant seeds; application in the form of powder coating on plant seeds; mixing with plant seeds; and mixing with a fertilizer. Control of a plant disease can be achieved by application in an application manner such as those described above, and preferable application manners are foliar application and seedling box treatment.

The plant disease control composition according to the present disclosure exerts a sufficient effect against a plant disease regardless of the application manner adopted in the plant disease control method.

The plant disease control composition according to the present disclosure may be mixed with a harmful-organism control agent such as an insecticide, a miticide, or a herbicide, before application.

Alternatively, the plant disease control composition according to the present disclosure and the harmful-organism control agent may be applied separately at different points of time.

Examples of the insecticide include acephate, dichlorvos, EPN, fenitrothion, fenamifos, prothiofos, profenofos, pyraclofos, chlorpyrifos-methyl, chlorfenvinphos, demeton, ethion, malathion, coumaphos, isoxathion, fenthion, diazinon, thiodicarb, aldicarb, oxamyl, propoxur, carbaryl, fenobucarb, ethiofencarb, fenothiocarb, pirimicarb, carbofuran, carbosulfan, furathiocarb, hyquincarb, alanycarb, methomyl, benfuracarb, cartap, thiocyclam, bensultap, dicofol, tetradifon, acrinathrin, bifenthrin, cycloprothrin, cyfluthrin, dimefluthrin, empenthrin, fenfluthrin, fenpropathrin, imiprothrin, metofluthrin, permethrin, phenothrin, resmethrin, tefluthrin, tetramethrin, tralomethrin, transfluthrin, cypermethrin, deltamethrin, cyhalothrin, fenvalerate, fluvalinate, ethofenprox, flufenprox, halfenprox, silafluofen, cyromazine, diflubenzuron, teflubenzuron, flucycloxuron, flufenoxuron, hexaflumuron, lufenuron, novaluron, penfluron, triflumuron, chlorfluazuron, diafenthiuron, methoprene, fenoxycarb, pyriproxyfen, halofenozide, tebufenozide, methoxyfenozide, chromafenozide, dicyclanil, buprofezin, hexythiazox, amitraz, chlordimeform, pyridaben, fenpyroxymate, flufenerim, pyrimidifen, tebufenpyrad, tolfenpyrad, fluacrypyrim, acequinocyl, cyflumetofen, flubendiamide, ethiprole, fipronil, ethoxazole, imidacloprid, nitenpyram, clothianidin, acetamiprid, dinotefuran, thiacloprid, thiamethoxam, pymetrozine, bifenazate, spirodiclofen, spiromesifen, flonicamid, chlorfenapyr, pyriproxyfene, indoxacarb, pyridalyl, spinosad, avermectin, milbemycin, azadirachtin, nicotine, rotenone, Bacillus thuringiensis (BT) microorganism, BT proteins, insect pathogenic viruses, emamectin benzoate, spinetoram, pyrifluquinazon, chlorantraniliprole, cyantraniliprole, cyenopyrafen, spirotetramat, lepimectin, metaflumizone, pyrafluprole, pyriprole, dimefluthrin, fenazaflor, hydramethylnon, triazamate, afidopyropen, and flupyrimin.

Examples of the miticide include bromopropylate, tetradifon, propargite, amitraz, fenothiocarb, hexythiazox, fenbutatin oxide, dienochlor, fenpyroximate, tebufenpyrad, pyridaben, pyrimidifen, clofentezine, etoxazole, halfenprox, milbemectin, acequinocyl, bifenazate, fluacrypyrim, spirodichlofen, spiromesifen, chlorfenapyr, Avermectin, cyenopyrafen, and cyflumetofen.

Examples of the herbicide include phenoxy acid-based compounds such as cyhalofop-butyl and 2,4-dichlorophenoxyacetic acid (2,4-D); carbamate-based compounds such as esprocarb and desmedipham; acid amide-based compounds such as alachlor and metolachlor; urea-based compounds such as diuron and tebuthiuron; sulfonylurea-based compounds such as halosulfuron-methyl and flazasulfuron; pyrimidyloxybenzoic acid-based compounds such as pyriminobac-methyl; amino acid-based compounds such as glyphosate, bilanafos, glufosinate, and glufosinate salts such as glufosinate-ammonium.

The plant disease control composition according to the present disclosure may be mixed with a chemical growth regulator or a fertilizer, before application. The plant disease control composition according to the present disclosure and the chemical growth regulator or fertilizer may be applied separately at different points of time.

Examples of the chemical growth regulator include: ethylene agents such as ethephon; auxin agents such as indolebutyric acid and ethychlozate; cytokinin agents; gibberellin agents; auxin antagonists; growth retardants; and antitranspirants.

Examples of the fertilizer include: nitrogen fertilizers such as urea, ammonium nitrate, magnesium ammonium nitrate, and ammonium chloride; phosphate fertilizers such as superphosphate of lime, ammonium phosphate, magnesium superphosphate, and magnesium phosphate; potassium fertilizers such as potassium chloride, potassium bicarbonate, magnesium potassium nitrate, potassium nitrate, and potassium sodium nitrate; manganese fertilizers such as manganese sulfate and manganese magnesium nitrate; and boron fertilizers such as boric acid and boric acid salts.

### EXAMPLES

The present disclosure is specifically described below with reference to formulation examples and test examples. However, the present disclosure is not limited to the formulation examples and test examples.

### (Formulation Example 1) Wettable Powder Formulation

20% by mass of Tebufloquin, 4% by mass of Fluoxastrobin, 56% by mass of clay, 2% by mass of white carbon, 13% by mass of diatomaceous earth, 4% by mass of calcium lignosulfonate, and 1% by mass of sodium lauryl sulfate were homogenously mixed and pulverized, to obtain a wettable powder formulation.

### (Formulation Example 2) Water-Dispersible Granule Formulation

10% by mass of Tebufloquin, 10% by mass of Tebuconazole, 70% by mass of clay, 5% by mass of dextrin, 4% by mass of alkylmaleic acid copolymer, and 1% by mass of sodium lauryl sulfate were homogenously mixed and pulverized. Water was added thereto, and the mixture was thoroughly kneaded. Then, the mixture was subjected to granulation and drying, to obtain a water-dispersible granule formulation.

### (Formulation Example 3) Flowable Formulation

10% by mass of Tebufloquin, 20% by mass of Ciproconazole, 5% by mass of polyoxyethylene polystrylphenyl ether sulfuric acid salt, 6% by mass of propyleneglycol, 1% by mass of bentonite, 0.05% by mass of a silicone-based antifoam agent (tradename: PRONAL EX-300, manufactured by TOHO Chemical Industry Co., Ltd.), and 0.02% by mass of an antifungal agent (tradename: ADDAC 827, manufactured by K-I Chemical Industry Co., Ltd.) were mixed. Thereafter, an appropriate amount of water was added thereto, and the mixture was crushed using a wet crusher. Thereafter, 3% by mass of a 1% xanthan gum aqueous solution and water as the balance were added to adjust the total amount to 100% by mass, to obtain a flowable powder formulation.

### (Formulation Example 4) Emulsifiable Concentrate Formulation

1% by mass of Tebufloquin, 10% by mass of Inpyrfluxam, 20% by mass of N,N-dimethylformamide, 59% by mass of an aromatic solvent (tradename: T-SOL 150, manufactured by ENEOS Corporation), and 10% by mass of polyoxyethylene alkylaryl ether were homogenously mixed for dissolution, whereby an emulsifiable concentrate was obtained.

### (Formulation Example 5) Dry Flowable Formulation

10% by mass of Tebufloquin, 10% by mass of Pyraziflumid, 65% by mass of kaolin clay, 5% by mass of dextrin, 5% by mass of alkyl maleic acid copolymer, and 5% by mass of sodium lauryl sulfate were homogenously mixed and pulverized. Water was added thereto, and the mixture was thoroughly kneaded. Then, the mixture was subjected to granulation and drying, to obtain a dry flowable formulation.

### (Formulation Example 6) Dust Formulation

0.5% by mass of Tebufloquin, 5.0% by mass of Pyroquilon, 57.5% by mass of clay, 36% by mass of talc, and 1% by mass of calcium stearate were homogenously mixed, to obtain a dust formulation.

### (Formulation Example 7) DL Dust Formulation

10% by mass of Tebufloquin, 1% by mass of Ipflufenoquin, 96.5% by mass of DL clay (tradename: Showa DL clay, manufactured by Showa KDE Co., Ltd.), 2% by mass of white carbon, and 0.5% by mass of light liquid paraffin were homogenously mixed, to obtain a DL dust formulation.

### (Test Example 1) Preventive Spray Treatment Against Rice Blast

An acetone aqueous solution (plant disease control composition) prepared as described below was used as a test solution, and a control efficacy and a theoretical value were calculated. The results are indicated in Tables 1 to 16.

Tebufloquin and the microbicide indicated in Tables 1 to 16 were dissolved in acetone. The acetone solution was diluted with water such that the concentrations of the microbicides became the concentrations indicated in Tables 1 to 16, and a 1/1000 volume of a wetting agent (NEO-ESTERIN manufactured by Kumiai Chemical Industry Co., Ltd.) was added, as a result of which a spray solution was obtained.

Eight to ten grains of rice seeds (cultivar: Jukkoku) were sown in a small pot having a diameter of 3 cm, and cultivated in a cultivation soil in a greenhouse. To seedlings in the 2-leave stage or 3-leave stage, 2 mL of the spray solution prepared as described above were sprayed, and air-dried.

Conidia of Pyricularia oryzae that had been cultured on an agar medium were suspended at a concentration of from 1×10⁵ conidia/mL to 5×10⁵ conidia/mL A solution obtained by 4000-fold dilution of Tween 20 with deionized water was used for the suspension liquid. This Pyricularia oryzae conidia suspension liquid was sprayed onto rice plants for inoculation, and infection was allowed to proceed in the dark in a moist chamber for 24 hours. Thereafter, the rice plants were cultivated in a greenhouse at 25° C./18° C. (day/night), and the disease developed on the rice leaves 7 to 9 days after the inoculation. The control efficacy was calculated according to the following equation based on the number of blast lesions. Then, testing using the Colby's equation shown below was performed to determine the presence or absence of a synergistic effect.

Control Efficacy=((Number of Lesions in Untreated Field−Number of Lesions in Treated Field)/Number of Lesions in Untreated Field)×100

Theoretical Value=(Control Efficacy A+Control Efficacy B)−(Control Efficacy A×Control Efficacy B)/100 (Colby's Equation)

In the results indicated in each of the following Tables, the actual control efficacy is higher than the Colby's theoretical value, thus confirming the presence of a synergistic effect.

TABLE 1

| Plant Disease | | | Control | Theoretical |
|---|---|---|---|---|
| Control Composition | Spray Concentration | | Efficacy | Value |
| Tebufloquin | 5 | ppm | 69 | — |
| Tebufloquin | 20 | ppm | 97 | — |
| Pyraclostrobin | 0.01 | ppm | 44 | — |
| Pyraclostrobin | 0.1 | ppm | 64 | — |

| Tebufloquin + | 5 ppm + 0.1 ppm | 97 | 89 |
|---|---|---|---|
| Pyraclostrobin | | | |
| Tebufloquin + | 20 ppm + 0.01 ppm | 100 | 98 |
| Pyraclostrobin | | | |

TABLE 2

| Plant Disease | | | Control | Theoretical |
|---|---|---|---|---|
| Control Composition | Spray Concentration | | Efficacy | Value |
| Tebufloquin | 5 | ppm | 78 | — |
| Picoxystrobin | 0.01 | ppm | 22 | — |
| Picoxystrobin | 0.1 | ppm | 68 | — |

| | | | |
|---|---|---|---|
| Tebufloquin + | 5 ppm + 0.01 ppm | 92 | 83 |
| Picoxystrobin | | | |
| Tebufloquin + | 5 ppm + 0.1 ppm | 97 | 93 |
| Picoxystrobin | | | |

TABLE 3

| Plant Disease | | | Control | Theoretical |
|---|---|---|---|---|
| Control Composition | Spray Concentration | | Efficacy | Value |
| Tebufloquin | 5 | ppm | 78 | — |
| Tebufloquin | 20 | ppm | 97 | — |
| Fluoxastrobin | 0.01 | ppm | 22 | — |
| Fluoxastrobin | 1 | ppm | 93 | — |

| | | | |
|---|---|---|---|
| Tebufloquin + | 5 ppm + 1 ppm | 99 | 98 |
| Fluoxastrobin | | | |
| Tebufloquin + | 20 ppm + 0.01 ppm | 99 | 98 |
| Fluoxastrobin | | | |

TABLE 4

| Plant Disease | | | Control | Theoretical |
|---|---|---|---|---|
| Control Composition | Spray Concentration | | Efficacy | Value |
| Tebufloquin | 10 | ppm | 84 | — |
| Tebufloquin | 20 | ppm | 97 | — |
| Mandestrobin | 0.1 | ppm | 0 | — |

| | | | |
|---|---|---|---|
| Tebufloquin + | 10 ppm + 0.1 ppm | 91 | 84 |
| Mandestrobin | | | |
| Tebufloquin + | 20 ppm + 0.1 ppm | 100 | 97 |
| Mandestrobin | | | |

TABLE 5

| Plant Disease | | | Control | Theoretical |
|---|---|---|---|---|
| Control Composition | Spray Concentration | | Efficacy | Value |
| Tebufloquin | 20 | ppm | 97 | — |
| Trifloxystrobin | 0.01 | ppm | 75 | — |

| | | | |
|---|---|---|---|
| Tebufloquin + | 20 ppm + 0.01 ppm | 100 | 99 |
| Trifloxystrobin | | | |

TABLE 6

| Plant Disease Control | | | Control | Theoretical |
|---|---|---|---|---|
| Composition | Spray Concentration | | Efficacy | Value |
| Tebufloquin | 5 | ppm | 59 | — |
| Tebufloquin | 20 | ppm | 90 | — |
| Mefentrifluconazole | 25 | ppm | 35 | — |
| Mefentrifluconazole | 100 | ppm | 44 | — |

| | | | |
|---|---|---|---|
| Tebufloquin + | 5 ppm + | 85 | 77 |
| Mefentrifluconazole | 100 ppm | | |
| Tebufloquin + | 20 ppm + | 96 | 94 |
| Mefentrifluconazole | 25 ppm | | |

TABLE 7

| Plant Disease Control | | Control | Theoretical |
|---|---|---|---|
| Composition | Spray Concentration | Efficacy | Value |
| Tebufloquin | 10 ppm | 76 | — |
| Tebufloquin | 20 ppm | 90 | — |
| Tebuconazole | 10 ppm | 58 | — |
| Tebufloquin + | 10 ppm + | 95 | 90 |
| Tebuconazole | 10 ppm | | |
| Tebufloquin + | 20 ppm + | 98 | 96 |
| Tebuconazole | 10 ppm | | |

TABLE 8

| Plant Disease Control | | | Control | Theoretical |
|---|---|---|---|---|
| Composition | Spray Concentration | | Efficacy | Value |
| Tebufloquin | 5 | ppm | 6 | — |
| Tebufloquin | 20 | ppm | 70 | — |
| Hexaconazole | 25 | ppm | 55 | — |
| Hexaconazole | 100 | ppm | 86 | — |

| | | | |
|---|---|---|---|
| Tebufloquin + | 5 ppm + | 94 | 87 |
| Hexaconazole | 100 ppm | | |
| Tebufloquin + | 20 ppm + | 97 | 87 |
| Hexaconazole | 25 ppm | | |

TABLE 9

| Plant Disease Control | | | Control | Theoretical |
|---|---|---|---|---|
| Composition | Spray Concentration | | Efficacy | Value |
| Tebufloquin | 10 | ppm | 86 | — |
| Prothioconazole | 1 | ppm | 39 | — |
| Prothioconazole | 100 | ppm | 95 | — |

| | | | |
|---|---|---|---|
| Tebufloquin + | 10 ppm + | 92 | 91 |
| Prothioconazole | 1 ppm | | |
| Tebufloquin + | 10 ppm + | 100 | 99 |
| Prothioconazole | 100 ppm | | |

TABLE 10

| Plant Disease Control | | | Control | Theoretical |
|---|---|---|---|---|
| Composition | Spray Concentration | | Efficacy | Value |
| Tebufloquin | 20 | ppm | 90 | — |
| Prothioconazole | 1 | ppm | 20 | — |
| Prothioconazole | 25 | ppm | 82 | — |

| | | | |
|---|---|---|---|
| Tebufloquin + | 20 ppm + | 93 | 92 |
| Prothioconazole | 1 ppm | | |
| Tebufloquin + | 20 ppm + | 99 | 98 |
| Prothioconazole | 25 ppm | | |

TABLE 11

| Plant Disease Control | | | Control | Theoretical |
|---|---|---|---|---|
| Composition | Spray Concentration | | Efficacy | Value |
| Tebufloquin | 5 | ppm | 69 | — |
| Tebufloquin | 10 | ppm | 84 | — |
| Ciproconazole | 10 | ppm | 11 | — |

| | | | |
|---|---|---|---|
| Tebufloquin + | 5 ppm + | 76 | 72 |
| Ciproconazole | 10 ppm | | |
| Tebufloquin + | 10 ppm + | 100 | 86 |
| Ciproconazole | 10 ppm | | |

TABLE 12

| Plant Disease Control | | | Control | Theoretical |
|---|---|---|---|---|
| Composition | Spray Concentration | | Efficacy | Value |
| Tebufloquin | 10 | ppm | 51 | — |
| Propiconazole | 100 | ppm | 72 | — |

| | | | |
|---|---|---|---|
| Tebufloquin + | 10 ppm + | 94 | 86 |
| Propiconazole | 100 ppm | | |

TABLE 13

| Plant Disease Control | | | Control | Theoretical |
|---|---|---|---|---|
| Composition | Spray Concentration | | Efficacy | Value |
| Tebufloquin | 5 | ppm | 59 | — |
| Tebufloquin | 20 | ppm | 90 | — |
| Diphenoconazole | 50 | ppm | 62 | — |
| Diphenoconazole | 100 | ppm | 86 | — |

| | | | |
|---|---|---|---|
| Tebufloquin + | 5 ppm + | 95 | 94 |
| Diphenoconazole | 100 ppm | | |
| Tebufloquin + | 20 ppm + | 99 | 96 |
| Diphenoconazole | 50 ppm | | |

TABLE 14

| Plant Disease Control | | | Control | Theoretical |
|---|---|---|---|---|
| Composition | Spray Concentration | | Efficacy | Value |
| Tebufloquin | 10 | ppm | 86 | — |
| Penflufen | 1 | ppm | 11 | — |

| | | | |
|---|---|---|---|
| Tebufloquin + | 10 ppm + | 97 | 88 |
| Penflufen | 1 ppm | | |

TABLE 15

| Plant Disease Control | | | Control | Theoretical |
|---|---|---|---|---|
| Composition | Spray Concentration | | Efficacy | Value |
| Tebufloquin | 10 | ppm | 51 | — |
| Inpyrfluxam | 100 | ppm | 74 | — |

| | | | |
|---|---|---|---|
| Tebufloquin + | 10 ppm + | 95 | 87 |
| Inpyrfluxam | 100 ppm | | |

TABLE 16

| Plant Disease Control | | | Control | Theoretical |
|---|---|---|---|---|
| Composition | Spray Concentration | | Efficacy | Value |
| Tebufloquin | 10 | ppm | 48 | — |
| Pyraziflumid | 10 | ppm | 0 | — |
| Pyraziflumid | 100 | ppm | 56 | — |

| | | | |
|---|---|---|---|
| Tebufloquin + | 10 ppm + | 61 | 48 |
| Pyraziflumid | 10 ppm | | |
| Tebufloquin + | 10 ppm + | 97 | 77 |
| Pyraziflumid | 100 ppm | | |

TABLE 17

| Plant Disease Control | | | Control | Theoretical |
|---|---|---|---|---|
| Composition | Spray Concentration | | Efficacy | Value |
| Tebufloquin | 10 | ppm | 51 | — |
| Pyroquilon | 100 | ppm | 22 | — |

| | | | |
|---|---|---|---|
| Tebufloquin + | 10 ppm + | 80 | 62 |
| Pyroquilon | 100 ppm | | |

TABLE 18

| Plant Disease Control | | | Control | Theoretical |
|---|---|---|---|---|
| Composition | Spray Concentration | | Efficacy | Value |
| Tebufloquin | 10 | ppm | 84 | — |
| Tebufloquin | 20 | ppm | 97 | — |
| Ipflufenoquin | 0.01 | ppm | 0 | — |
| Ipflufenoquin | 0.1 | ppm | 76 | — |

| | | | |
|---|---|---|---|
| Tebufloquin + | 10 ppm + | 92 | 84 |
| Ipflufenoquin | 0.01 ppm | | |
| Tebufloquin + | 20 ppm + | 100 | 99 |
| Ipflufenoquin | 0.1 ppm | | |

### (Test Example 2) Long-Term Control Effect Against Rice Blast

An acetone aqueous solution (plant disease control composition) prepared as described below was used as a test solution, and a control efficacy and a theoretical value were calculated. The results are indicated in Tables 19 and 20.

Tebufloquin and the microbicide indicated in Tables 19 and 20 were dissolved in acetone. The acetone solution was diluted with water such that the concentrations of the microbicides became the concentrations indicated in Tables 19 and 20, and a 1/1000 volume of a wetting agent (NEO-ESTERIN manufactured by Kumiai Chemical Industry Co., Ltd.) was added, as a result of which a spray solution was obtained.

Fifteen grams of rice seeds (cultivar: Jukkoku) were sown in a 30 cm×20 cm small vat, and cultivated in a greenhouse at 25° C./18° C. (day/night).

Conidia of Pyricularia oryzae that had been cultured on an agar medium were suspended at a concentration of from 1×10⁴ conidia/mL to 5×10⁴ conidia/mL A solution obtained by 4000-fold dilution of Tween 20 with deionized water was used for the suspension liquid. This Pyricularia oryzae conidia suspension liquid was sprayed onto rice seedlings at 2-leave stage for inoculation, and infection was allowed to proceed in the dark in a moist chamber for 24 hours. Thereafter, the rice seedlings were cultivated in the greenhouse, and blast lesions were observed on the rice leaves 7 to 9 days after the inoculation.

After the presence of a lesion on the 2 leaves was confirmed, 12 ml of the spray solution described above was sprayed, and naturally dried indoors. Thereafter, the rice seedlings were left to stand still in a humid chamber (temperature: 25° C., humidity: 100%) for 24 hours, thereby allowing the rice seedlings to be naturally infected with Pyricularia oryzae in the vat.

One week later, natural infection for 24 hours was carried out in the same manner. Thereafter, the rice seedlings were cultivated in a greenhouse set at 25° C./18° C. (day/night) for 7 to 9 days, and the number of rice blast lesions formed on the uppermost unfolded leaf of each of randomly sampled 50 seedlings was counted. The control efficacy was calculated according to the following equation based on the number of lesions obtained. Then, testing using the Colby's equation shown below was performed to determine the presence or absence of a synergistic effect.

Control Efficacy=((Number of Lesions in Untreated Field−Number of Lesions in Treated Field)/Number of Lesions in Untreated Field)×100

Theoretical Value=(Control Efficacy A+Control Efficacy B)−(Control Efficacy A×Control Efficacy B)/100 (Colby's Theoretical Equation)

In the results indicated in Tables 19 and 20, the actual control efficacy is higher than the Colby's theoretical value, thus confirming the presence of a synergistic effect.

TABLE 19

| Plant Disease Control | | Control | Theoretical |
|---|---|---|---|
| Composition | Spray Concentration | Efficacy | Value |
| Tebufloquin | 83 ppm | 80 | — |
| Propiconazole | 52 ppm | 55 | — |
| Tebufloquin + | 83 ppm + | 94 | 91 |
| Propiconazole | 52 ppm | | |

TABLE 20

| Plant Disease Control | | Control | Theoretical |
|---|---|---|---|
| Composition | Spray Concentration | Efficacy | Value |
| Tebufloquin | 83 ppm | 81 | — |
| Tebuconazole | 52 ppm | 63 | — |
| Tebufloquin + | 83 ppm + | 94 | 93 |
| Tebuconazole | 52 ppm | | |

### INDUSTRIAL APPLICABILITY

The plant disease control composition according to the present disclosure has an excellent control effect against rice blast, and is a composition useful for agricultural applications.

The disclosure of Japanese Patent Application No. 2022-052592, filed Mar. 28, 2022, is incorporated herein by reference in its entirety. All publications, patent applications, and technical standards mentioned in this specification are herein incorporated by reference to the same extent as if each individual publication, patent application, or technical standard was specifically and individually indicated to be incorporated by reference.

1. A plant disease control composition, comprising Tebufloquin and a microbicide other than Tebufloquin as active components,
the microbicide including at least one selected from the group consisting of Pyraclostrobin, Picoxystrobin, Fluoxastrobin, Mandestrobin, Trifloxystrobin, Azaconazol, Bitertanol, Bromuconazole, Ciproconazole, Diphenoconazole, Diniconazole, Epoxiconazole, Etaconazole, Fenbuconazole, Fluquinconazole, Flusilazole, Flutriafol, Hexaconazole, Imibenconazole, Ipconazole, Mefentrifluconazole, Metconazole, Myclobutanil, Penconazole, Propiconazole, Prothioconazole, Simeconazole, Mefentrifluconazole, Tebuconazole, Tetraconazole, Triadimefon, Triadimenol, Triticonazole, Penflufen, Inpyrfluxam, Fluindapyr, Pyraziflumid, Penthiopyrad, Fluopyram, Pyridachlometyl, Pyroquilon, and Ipflufenoquin.

2. The plant disease control composition according to claim 1, wherein the microbicide comprises at least one selected from the group consisting of Pyraclostrobin, Picoxystrobin, Fluoxastrobin, Mandestrobin, Trifloxystrobin, Prothioconazole, Mefentrifluconazole, Ciproconazole, Diphenoconazole, Hexaconazole, Propiconazole, Tebuconazole, Penflufen, Inpyrfluxam, Pyraziflumid, Pyroquilon, and Ipflufenoquin.

3. The plant disease control composition according to claim 1, wherein the plant disease is blast disease.

4. A formulation comprising the plant disease control composition of claim 1.

5. The formulation according to claim 4, wherein the formulation is selected from the group consisting of a wettable powder formulation, an emulsifiable concentrate formulation, a flowable formulation, a water-dispersible granule formulation, a dry flowable formulation, a dust formulation, a low drift (DL) dust formulation, a flow dust (FD) formulation, a microcapsule formulation, a granule formulation, a dust-granule mixture formulation; a jumbo-pellet formulation, a pack formulation, and an aerosol formulation.

6. A plant disease control method comprising applying the plant disease control composition of claim 1 to a plant disease.

7. The plant disease control method according to claim 6, wherein the plant disease is blast disease.

8. The plant disease control method according to claim 6, wherein the applying includes at least one treatment selected from foliar application or seedling box treatment.
